(19) United States
(12) Patent Application Publication
(10) Pub. No.: US 2026/0367331 A1
(43) Pub. Date: Nov. 19, 2026

(54) CAVITY INSPECTION AND/OR MACHINING SYSTEM

(71) Applicant: IBAK Helmut Hunger GmbH & Co. KG, Kiel (DE)

(72) Inventors: Felix RAHN, Kiel (DE); Markus STOCK, Kiel (DE)

(21) Appl. No.: 19/678,339

(22) Filed: May 15, 2026

(30) Foreign Application Priority Data
May 16, 2025 (DE) 10 2025 119 061.5

(51) Int. Cl. G02B 6/36; G01N 21/954; G02B 6/38; G02B 23/24

(52) U.S. Cl. CPC G02B 6/3604; G01N 21/954; G02B 6/3817; G02B 23/2453; G02B 23/2484; G01N 2021/9546

(57) ABSTRACT

A cavity inspection system and/or cavity machining system includes a probe (2) which can be inserted into a cavity and with a cable (6). The cable is connected to the probe and includes an optic fiber (26) and a rotary coupling (12). The rotary coupling has two coupling parts (14, 16) which are connectable rotationally fixed. A ferrule (38, 40) is connected to an end of the optic fiber (26, 28), arranged each in the two coupling parts. At least one ferrule is rotatably mounted in the associated coupling part. The ferrules are in engagement with a sleeve (48) which bears on the outer circumference of the ferrules such that the ferrules are aligned with one another by the surrounding sleeve. At least one of the ferrules is rotatable about its longitudinal axis (D) in an inside of the sleeve. The rotary coupling (12) is also provided.

### CROSS REFERENCE TO RELATED APPLICATIONS

This application claims the benefit of priority under 35 U.S.C. §119 of German Application 10 2025 119 061.5, filed May 16, 2025, the entire contents of which are incorporated herein by reference.

### TECHNICAL FIELD

The invention relates to a cavity inspection system and/or cavity machining system, as well as to a rotary coupling for an optic fiber cable, in particular for use in such a cavity inspection system and/or cavity machining system.

### BACKGROUND

Cavity inspection systems are applied for example in order to inspect sewer pipes. Such systems comprise a probe with a camera which via a supply and data cable is connected to a control device which is arranged outside the sewer pipe, and a reel for winding up the cable. Since the reel is rotated and the camera as a rule is also freely rotatable, rotary couplings are necessary in the cable. If the cable comprises electrical leads for the supply of energy and an optic fiber cable for the data transmission, rotatable interfaces for the electrical transmission and light transmission are hence necessary in the rotary coupling. A pipe conduit inspection device and/or pipe conduit machining device with such a coupling is known for example from DE 10 2021 208 655 A1.

When coupling optic fibers, there is the problem that the lenses at the ends of the optic fibers to be coupled need to be aligned in a manner in which they are axially aligned with one another. This demands high manufacturing tolerances and precision on assembly.

### SUMMARY

Against this background, it is the object of the invention to provide a cavity inspection system and/or cavity machining system, with a rotary coupling for an optic fiber, regarding which a precise alignment of the optical components of the coupling to one another can be realized in a simple manner.

This object is achieved by a cavity inspection system and/or cavity machining system with at least some of the features disclosed herein, as well as by a rotary coupling with at least some of the features disclosed herein. Preferred embodiments are disclosed in this written description, the associated claims, as well as the attached figures.

The cavity inspection system and/or cavity machining system according to the invention serves for inspecting cavities such as for example, sewer pipes or shafts and/or for carrying out machining procedures in the inside of such cavities. Such machining procedures, for example can be milling tasks which are carried out with suitable milling tools. Hence the cavity inspection system and/or cavity machining system according to the invention is preferably a sewer pipe inspection system and/or sewer pipe machining system, which is provided for the inspection and/or the machining of sewer constructions such as sewer pipes or shafts. The system comprises at least one probe which can be introduced into a cavity, for example a sewer pipe or a shaft. The probe preferably comprises at least one camera for the inspection of the cavity. Alternatively, or additionally, at least one machining tool can be arranged on the probe, in order to carry out machining tasks in the inside of a cavity. Hence the probe can comprise, for example, a rotating miller. The probe is connected to a cable which in particular serves for the data transmission from the probe to a remote control device and possibly vice versa from the control device to the probe. If the probe comprises a camera, which is to say it is the case of a camera probe, then the cable in particular serves for transmitting picture or video data from the probe to a remote control device or processing device. For this, according to the invention the cable comprises at least one optic fiber. This cable further comprises at least one rotary coupling or is connected to such a rotary coupling. Such a rotary coupling is necessary for example if the cable can be wound on a reel and/or if the probe is to be rotatable relative to the cable about the longitudinal axis.

According to the invention, the rotary coupling comprises two coupling parts which are connected to one another in a rotationally fixed manner or are connectable to one another. These two coupling parts in particular can form an outer housing of the coupling which forms an adequately firm, mechanical connection and protects further components of the rotary coupling in the inside. A ferrule is arranged in each of the two coupling parts. The ferrules are each connected to one end of an optic fiber and form an optical interface or coupling between the two optic fibers. The ferrules are preferably fixedly connected, in particular welded, to the optic fibers and hence form the optical end of an optic fiber, from which end light exits or through which light can be led into the optic fiber. At least one of the two ferrules is rotatably mounted in the associated coupling part, which is to say in the coupling part in which the ferrule is arranged. Herein, the ferrule is rotatably mounted in a manner such that it can rotate in the inside of the coupling part about its longitudinal axis which corresponds to the optical axis along which light exits the ferrule or can be led into the ferrule. Hence together with the ferrule, the optic fiber which is connected to the ferrule can rotate about its longitudinal axis relative to the associated coupling part and herewith relative to both coupling parts which are connected to one another as well as relative to the optic fiber which is connected to the other coupling part. In particular, the ferrule is arranged in a freely rotatable manner, so that the rotation angle is not limited and can rotate or twist arbitrarily often about its longitudinal axis.

Furthermore, the ferrules are both in engagement with a sleeve which bears on the outer circumference of the ferrules. The sleeve comprises two open longitudinal ends, wherein the two ferrules engage into the sleeve from these open longitudinal ends, so that they lie opposite one another in the sleeve. This is to say that a first ferrule engages into the first axial longitudinal end of the sleeve, whereas the second ferrule engages into the oppositely directed, second open longitudinal end of the sleeve. The ferrules on their outer circumference are designed in a circularly cylindrical manner and the sleeve has a circularly cylindrical inner cross section, so that the sleeve can come into bearing contact on the outer circumference of the ferrule. Herein, the two ferrules are aligned due to the surrounding sleeve, which is to say that they are aligned with their longitudinal axes or optical axes aligned with one another. For this, a play-free bearing contact of the inner circumference of the sleeve on the outer circumference of the ferrules is given. At least one of the two ferrules is rotatable about its longitudinal axis in the inside of the sleeve, wherein the outer circumference of this ferrule is slidingly guided on the inner wall of the sleeve, so that the aligned alignment of the two ferrules to one another is retained given the rotation. The sleeve realizes a reliable alignment of the two ferrules to one another in a simple manner, independently of the mounting of the ferrules in the two coupling parts. It is because of this that the necessary tolerances on mounting in the coupling parts can be reduced and thus a reliably aligned arrangement of the ferrules to one another can be realized in a coupling which is inexpensive to manufacture and simple to assemble.

The two ferrules at their axial ends which face one another each comprise a light exit surface and preferably a lens. Light can exit via the light exit surface of the one ferrule and then enter into the light exit surface of the other ferrule and vice versa. If the light exit surfaces are designed in a lens-like manner or are realized by a lens which is connected to the ferrule, the exiting radiation can be simultaneously collimated, so that the light beams are directed essentially parallel to the optical axis between the two ferrules, so that a light transmission between the two light exit surfaces of the adjacent ferrules having low as possible losses is ensured. Herein, the light exit surfaces lie opposite one another aligned in defined manner due to the aligned arrangement of the ferrules.

The sleeve is preferably designed in a resilient manner in the radial direction, for example of metal, in particular spring steel. The resilient design can be realized for example by a slotted design of the sleeve. Given such a slotted design, the sleeve can comprise a slot in the longitudinal wall, said slot preferably extending over the entire length of the sleeve. Alternatively, several slots which extend over only part-sections of the axial length can also be provided. The sleeve is preferably designed such that in an idle position the inner diameter is slightly smaller than the outer diameter of the ferrules, so that the sleeve is widened elastically on inserting the ferrules, by which means a play-free bearing contact of the inner circumference of the sleeve on the outer circumference of the ferrules is ensured. Herein, the spring effect of the sleeve is preferably set such that the clamping force on at least one of the ferrules is such that the rotatability of the ferrule in the inside of the sleeve is retained.

Preferably, at least in one of the two coupling parts, the ferrule which is mounted or arranged there is arranged in a movable manner in at least one direction transverse to it longitudinal axis, which is to say is mounted with play. This ferrule is simultaneously arranged in the associated coupling part preferably in a rotationally fixed manner or rotatable only to a limited extent. Herein, the ferrule itself does not need to be directly mounted in the coupling part in this manner. The ferrule could also be fixed in a holding element which is arranged in a movable manner transversely to the longitudinal axis of the ferrule, which is to say mounted with play, and is preferably arranged in the associated coupling part in a rotational fixed manner or a manner rotatable only to a limited extent. Thus the described movable mounting of the ferrule can be realized via the holding element. Herewith, preferably a first ferrule is rotatably mounted in its coupling part about the longitudinal axis, wherein this rotatable mounting is preferably designed such that it is without play in the radial direction, so that the ferrule is rotatable about its longitudinal axis in a centered manner. The second ferrule which is arranged or mounted in the other, which is to say second coupling part, is preferably mounted in a direct or indirect manner such that it is not rotatable, but is mounted with play in the radial direction, so that it can move transversely to the longitudinal axis or to the optical axis by a certain amount and further preferably also pivot about an axis transverse to the longitudinal axis by a certain amount. In this manner, alignment errors and angular errors with respect to the first ferrule and which result from the mounting are compensated by the play. The ferrule which is mounted with play can move in order to align itself to the other ferrule in an aligning manner. The precise alignment relative to the first ferrule is herein effected by the sleeve, into which both ferrules engage. This means that on engagement into the sleeve, the ferrule which is mounted with play automatically aligns itself to the first ferrule in an aligning manner.

According to a further preferred embodiment, the coupling is designed as a releasable coupling, regarding which the two coupling parts can be joined together and separated again, in the axial direction and a releasable connection can be formed between the two coupling parts. Such a releasable connection can be achieved for example by way of a threaded engagement or also by a plug-in connection. Particularly preferably, one of the coupling parts comprises an outer thread, and a union nut with a corresponding inner thread which meshes into the outer thread of the other coupling part is arranged on the other coupling part. Hence the second coupling part can be secured on the first coupling part by way of a screw connection via the union nut. Both coupling parts are connected to one another in a rotationally fixed manner by way of the screw connection, wherein further preferably a positive engagement between the two coupling parts additionally exists, and this maintains the two coupling parts in a manner aligned to one another in a defined manner in their angular position and keeps them aligned in a rotationally fixed manner. If the coupling is separated and the two coupling parts disengage from one another, preferably at least one of the ferrules is brought out of engagement with the sleeve, which is to say is retracted out of the sleeve. On re-joining, the ferrule is again inserted into the sleeve, wherein the described axially aligned alignment between the two ferrules occurs.

According to a further possible embodiment of the invention, the sleeve is designed in a widened manner at an axial end. This means that the sleeve widens towards an axial end, in particular in a funnel-like manner. By way of this, an insert funnel is created, said insert funnel guiding the ferrule into the sleeve on sticking together. In particular, this is important if an angular error or a radial offset of the ferrule with respect to the longitudinal axis of the sleeve is to be given, so that the ferrule on insertion into the sleeve is guided into the position which is aligned to the sleeve and to the other ferrule. Preferably, the sleeve is widened at that axial end, into which the ferrule which is to be rotatable relative to the sleeve in the inside of the sleeve engages. According to a further possible embodiment of the invention, the sleeve is designed and arranged such that it can be withdrawn from both ferrules in the axial direction. This has the advantage that the free ends of both ferrules can be exposed, for example in order to be able to clean them.

According to a further possible embodiment, the two ferrules and the sleeve are designed in a manner such that in the axial direction the holding force between the sleeve and a first of the two ferrules is greater than between the sleeve and a second of the two ferrules. By way of this, it is ensured that given a releasable design of the coupling, the second ferrule is pulled out of the sleeve on separating the coupling, whereas the sleeve continues to be held on the first ferrule in a clamping manner. By way of this, a defined separation location is ensured on releasing the coupling. Despite this, the sleeve can also be removed from the first ferrule amid a high force action, in order for example to be able to clean the lens on the first ferrule. If the sleeve is designed in a widened manner at an axial end, then it is preferably widened at that axial end, into which the second of the two ferrules engages. Hence on separating the coupling, the second ferrule is pulled out of the sleeve and on joining together the second ferrule is inserted into the sleeve through the funnel-like widening of the sleeve until it is rotatably mounted there again in an aligned manner and preferably in a manner rotatable in the inside of the sleeve.

Particular preferably, the sleeve is designed in a widened manner at an axial end and that ferrule which engages into this widened axial end is arranged in the coupling part which belongs to this ferrule, in a movable manner transversely to its longitudinal axis. This preferably means that the second ferrule is mounted with play in the second coupling part. This is the ferrule which engages with the sleeve on coupling the coupling and disengages from it on separating the coupling. At the same time, this is preferably the ferrule which rotatably slides in the sleeve. The other, which is to say first ferrule, in contrast is held in the sleeve with a greater holding force, so that this does not disengage given a normal separation of the coupling. At the same time, the first ferrule is preferably that ferrule which is rotatably mounted in its associated coupling part, which is to say in the first coupling part, for example via a roller bearing in the inside of the coupling part.

According to a particular embodiment of the invention, apart from the optic fiber, the cable comprises at least one electrical lead, which is to say one or more electrical leads and the rotary coupling comprises at least one electric coupling and further preferably a separable electrical coupling. Particular preferably, at least two electrical leads which can serve for the energy supply of the probe are arranged in the cable. The rotary coupling is preferably designed such that it provides a rotatable electrical connection for the electrical leads, for example by one or more slip rings. If two electrical leads are provided, then preferably at least two electrically separated slip rings are provided. Furthermore, a separable electrical coupling is provided on the rotary feed-through and this permits a complete separation of the rotary coupling, for the optic fiber as well as for the electrical lead.

Further preferably, the described electrical coupling comprises electrical contacts which can be brought into engagement with one another or in bearing contact with one another. The electrical contacts are preferably each connected to the two coupling parts, so that electrical contacts which are on both coupling parts and are designed complementarily to one another engage with one another or come into bearing contact with one another on joining together the coupling parts. If the coupling parts are separated, then the complementary electrical contacts can disengage or be brought out of bearing contact with one another in the reverse manner, so that the coupling parts can be separated. On joining together the coupling parts, an electrical connection of the electrical leads is preferably created automatically via the electrical contacts.

In a further possible embodiment, the electrical coupling can be designed in a separable but simultaneously rotationally fixed manner, so that the electrical coupling only serves for the separable connection of the electrical leads between the coupling parts which are releasably connectable to one another, but not for the rotary feed-though. A non-separable electrical rotary feed-through, for example with one or more slip rings, is preferably arranged in one of the two coupling parts for the rotational feed-through. The separation of the rotary feed-through and the separable electrical coupling has the advantage that both can be optimized with regard their function, which is to say that on the one hand a reliably functioning rotary feed-through can be provided and on the other hand a reliably functioning separable electrical coupling can be provided.

According to a further possible embodiment of the invention, the described at least one electrical coupling is arranged in a region of the coupling parts or one of the coupling parts which circumferentially surrounds the ferrules. This means that the optic fiber with the two ferrules which lie opposite one another is arranged in the two coupling parts preferably in a central manner, which is to say in a manner aligned with the rotary axis, so that the optical coupling for the optic fiber, formed by the ferrules, can be joined together and separated in the direction of the rotation axis and at the same time the rotary feed-through which is necessary for the optical transmission is made possible via a relative rotation of the ferrules about the described rotation axis. The preferably non-rotatable and stationary electrical contacts of the electrical coupling can be arranged in a circumferential region of the ferrules. An electrical rotary feed-through is preferably axially distanced to the described optical coupling in the direction of the longitudinal or rotation axis, which is to say behind one of the ferrules seen in the direction of the rotation axis. This permits a compact construction of the complete rotary coupling if it comprises an optical and an electrical coupling and rotary feed-through.

In a further possible embodiment of the invention, the aforedescribed rotary coupling connects an axial end of the cable to a reel, wherein one of the two coupling parts is connected to the axial end of the cable, and the other of the two coupling parts is arranged on the reel. The coupling part which is arranged on the reel preferably comprises a rotatable part which is connected to a stationary part of the reel. This permits the cable with the rotary coupling to be able to rotate feely to the stationary part of the reel about the longitudinal axis. This is necessary for winding the cable on the reel. Alternatively, or additionally, a corresponding rotary coupling can also be arranged on the probe or a camera or at an arbitrary other location in a cable connection to the probe, at which location a free rotatability of the connection is necessary.

Apart from the aforedescribed cavity inspection system and/or cavity machining system, the subject matter of the invention is a rotary coupling for an optic fiber cable, wherein this rotary coupling is preferably provided and designed for use in a cavity inspection system and/or cavity machining system as has been described above. Preferred embodiments of the rotary coupling as have been described above with reference to the cavity inspection system and/or cavity machining system are likewise to be understood as preferred embodiment examples of the subsequently described rotary coupling. Conversely, subsequently described preferred features are also to be seen as preferred features of the cavity inspection system and/or cavity machining system.

The rotary coupling according to the invention comprises two coupling parts which are connected to one another or connectable to one another, in a rotationally fixed manner. This means that the coupling parts are preferably releasable, so that they can be brought into engagement with one another and are connectable and can be separated from one another in order to separate the rotary coupling. A ferrule which is connected to an end of an optic fiber is arranged in each of the two coupling parts. These ferrules form an optical coupling by way of them lying opposite one another with their axial ends which can further preferably be designed in a lens-like manner or can comprise a lens, so that the light which exits out of a first ferrule can enter into the axial end of the second ferrule and vice versa. The ferrules are aligned along a common optical axis, about which the ferrules are rotatable relative to one another. Hence an optical rotary coupling is created, in which light can be transmitted from one ferrule to the other and vice versa, whilst the two ferrules can be arranged in a manner freely rotatable to one another about the optical axis. In order to permit such, at least one ferrule is rotatably mounted in the associated coupling part. This permits both coupling parts to be able to be connected to one another in a rotationally fixed manner and for the optical rotary coupling or rotary feed-through to be made possible by way of the rotatable mounting of at least one of the ferrules. Thus the ferrules can be rotated relative to one another about the optic axis. The ferrules are in engagement with a sleeve which bears on the outer circumference of the ferrules, in a manner such that the two ferrules are aligned in a manner aligned with one another by way of this surrounding sleeve. For this, the sleeve is directed along the described optical axis, so that when the two ferrules engage into the sleeve, it aligns these ferrules to one another in an aligned manner along the optical axis. At least one of the two ferrules is rotatably mounted in the sleeve about its longitudinal axis. Thus, the ferrules can rotate relative to one another about the longitudinal axis which corresponds to the optical axis, but are herein kept aligned to one another via the sleeve. For this, the sleeve bears on the outer circumference of the ferrules preferably without play, wherein it slidingly bears on the at least one rotatable ferrule. The above description is referred to with regard to further preferred embodiments.

The invention is hereinafter described by way of example and by way of the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a cavity inspection system according to the invention;

FIG. 2 is a sectioned view of a rotary coupling according to the invention, in the separated state;

FIG. 3 is a sectioned view of the rotary coupling according to FIG. 2 in the joined-together state;

FIG. 4 is an enlarged detailed view of the electrical and optical contact region in the rotary coupling according to FIG. 3;

FIG. 5 is a schematic sectioned view of a rotary coupling according to the invention;

FIG. 6 is a sectioned perspective view of the rotary coupling according to FIG. 5; and

FIG. 7 is a plan view of the face side of the rotary coupling which is schematically shown in FIG. 6.

### DESCRIPTION OF PREFERRED EMBODIMENTS

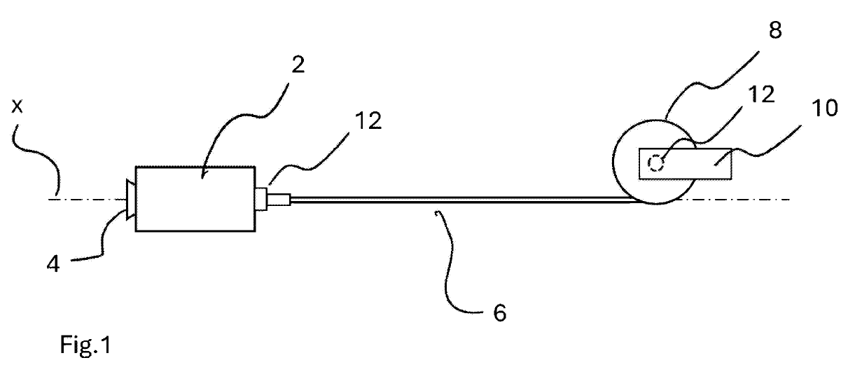

Referring to the drawings, FIG. 1 schematically shows a cavity inspection system according to the invention. This system comprises a probe 2 which is designed as a camera probe 2 with a camera 4. The probe 2 can be insertable into a sewer pipe for example along the advance axis X, in order to inspect the inside of this sewer pipe with the help of a camera 4. Apart from the camera 4, the probe 2 can yet also comprise in particular illumination means which are not shown here. Alternatively, or additionally, the probe 2 could also comprise a machining tool such as, for example, a miller. The probe 2 is connected to a reel 8 via a cable 6, said reel 8 being for winding up the cable 6. On the reel 8, the cable 6 is connected via a rotary coupling 12 as is described in detail hereinafter, to a stationary part 10 of the reel 8 which in turn can be connected to a control device for the probe 2 via cable connections which are not shown here. The probe 2 is also connected to the cable 6 preferably in a rotatable manner, in order to be able to rotate the probe 2 such that the camera 4 always retains a defined position and picture alignment. For this, a rotary coupling 12 as is described hereinafter can likewise be arranged between the probe 2 and the cable 6.

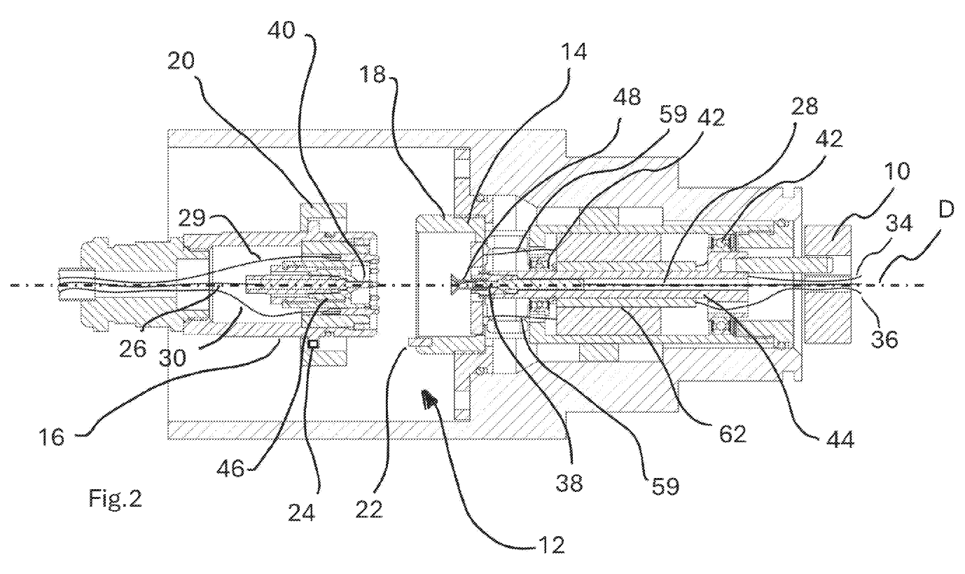

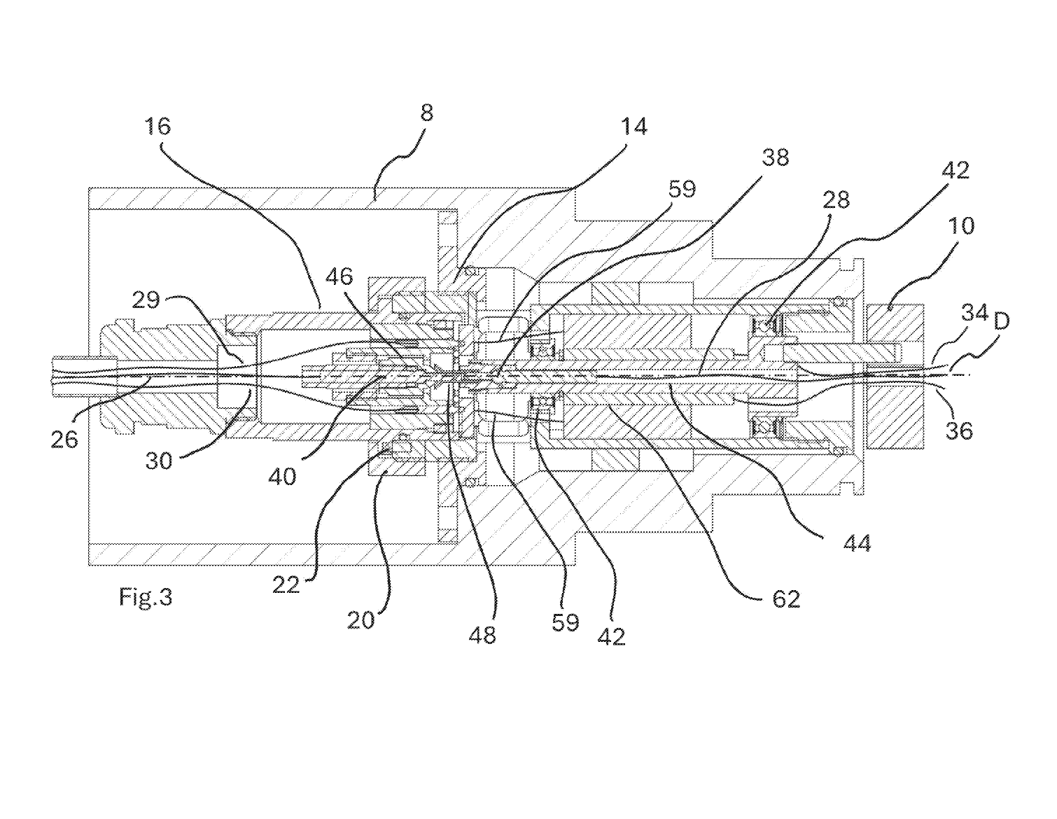

FIGS. 2-7 show a rotary coupling 12 or details of such a rotary coupling 12 as can be arranged for example on the reel 8. The rotary coupling 12 comprises two coupling parts 14 and 16. The two coupling parts 14 and 16 are releasably connectable to one another, wherein they assume a rotationally fixed connection. For the fixed connection, an outer thread 18 into which the inner thread of a union nut 20 can mesh is formed on the outer circumference of the first coupling part 14, said union nut being arranged on the second coupling part 16. The two coupling parts 14 and 16 can be held on one another in the axial direction D by way of the thread 18 and the union nut 20. A rotation of the two coupling parts 14, 16 to one another is blocked by a rotation lock which is formed by a pin 22 which projects axially from the first coupling part 14 and engages into a recess 24 on the second coupling part 16. The joined-together state is shown in FIG. 3. If the first coupling part 14 and the second coupling part 16 are coupled, then as is shown in FIG. 3 the second coupling part 16 engages into the first coupling part 14 and is secured on the first coupling part 14 with the help of the union nut 20. The rotation lock is effected by the pin 22.

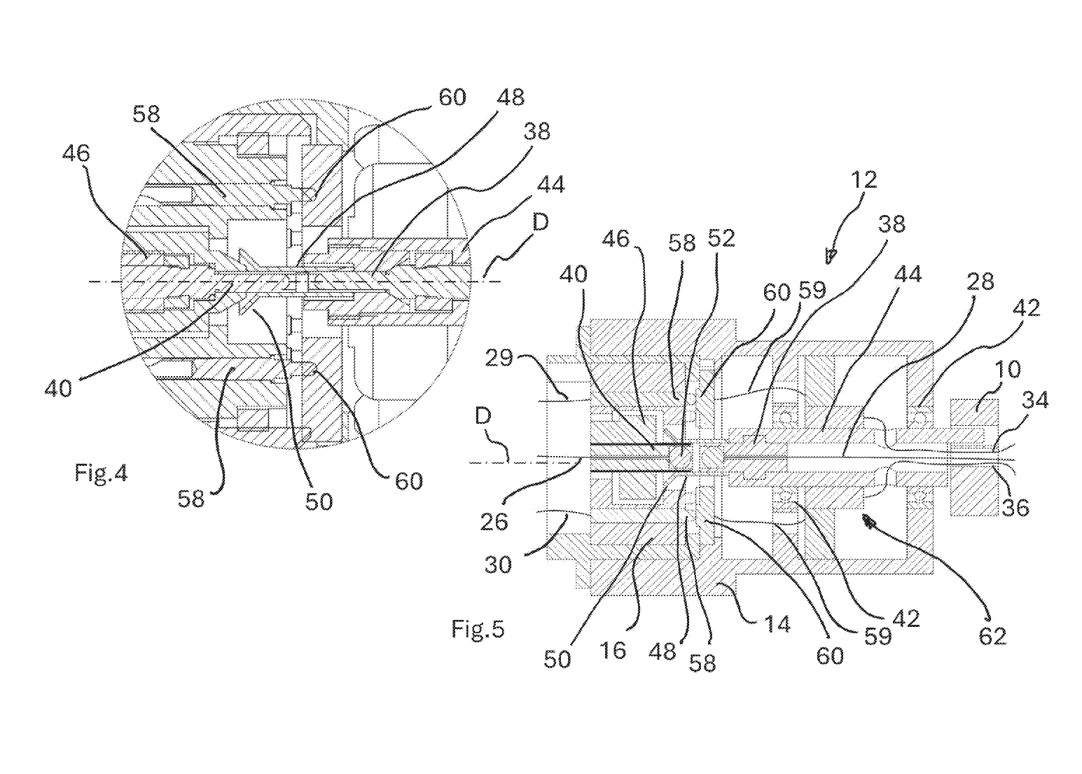

The cable 6 comprises an optic fiber 26 as well as several electrical leads 29, 30, of which two electrical leads are represented in FIGS. 2, 3 and 5. Accordingly, the rotary coupling 12 is designed such that it creates a releasable and rotatable connection between the optic fiber 26 and a connecting optic fiber 28 as well as between the electrical leads 29 and 30 as well as the connecting electrical leads 34 and 36. The precise design of the electrical and the optical coupling is described by way of FIG. 4 which represents an enlarged detail of FIG. 3. As shown more clearly in the schematic representation in FIG. 5, the optic fiber 28 ends in a first ferrule 38 and the optic fiber 26 ends in a second ferrule 40. The first ferrule 38 is rotatably mounted in the first coupling part 14 about the longitudinal or rotation axis D, in this example via two roller bearings 42. By way of this mounting, the ferrule 38 is mounted in the roller bearings 42 in an axial and radial manner with respect to the rotation axis D via a holding element 44 which surrounds the ferrule 38, so that the ferrule 38 is aligned in a defined manner in the direction of the rotation axis D. The second ferrule 40 is also mounted in the associated second coupling part 16 via a holding element 46. Herein, the ferrule 40 is fixed in the holding element 46 without play. The holding element 46 in turn is mounted with play in the second coupling part 16 such that it permits a certain radial offset with respect to the longitudinal or rotation axis D and also an angular offset with respect to the longitudinal axis D for the ferrule 40.

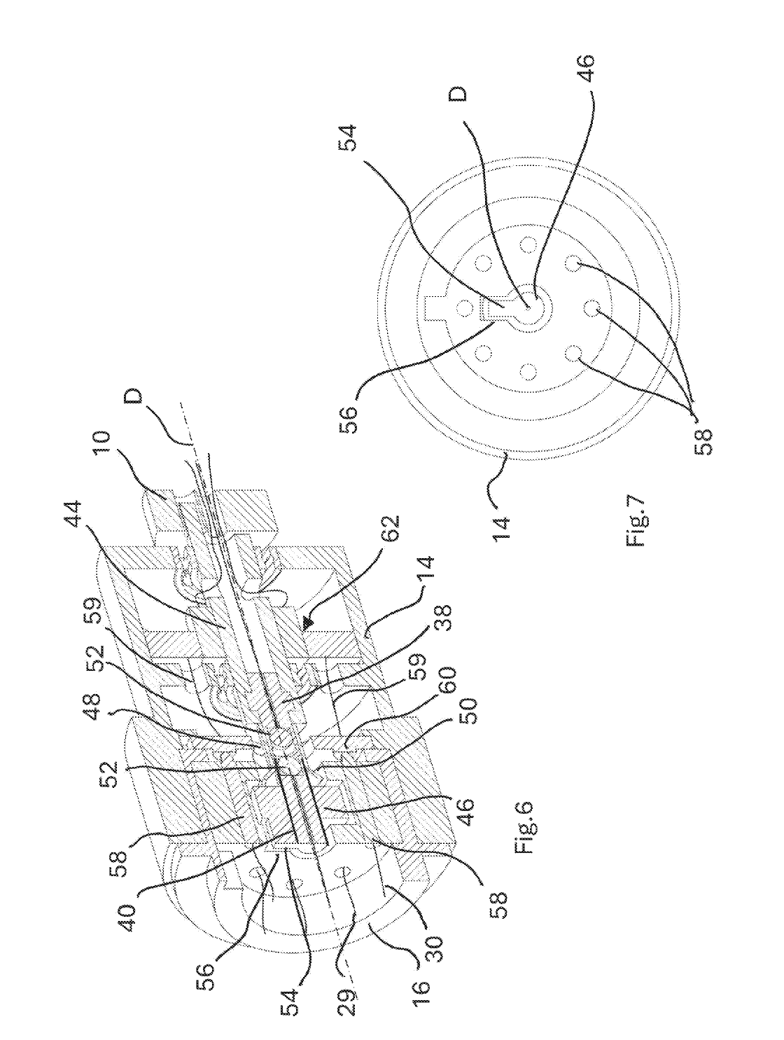

The two ferrules 38 and 40 engage with their free ends which lie opposite one another into a surrounding sleeve 48. The ferrules 38 and 40 fit in the inside of the sleeve 48 without play, which is to say the sleeve 48 bears on the outer circumference of the ferrules 38 and 40 without play. The sleeve 48 is designed in a resilient or elastic manner such that it effects a radially inwardly directed clamping force when the ferules 38, 40 are inserted into the sleeve 48. This can be realized for example by slotted design of a resilient metal sleeve which widens by a certain amount on inserting the ferrules 38 and 40. The end of the sleeve 48 which faces the second coupling part 16 is widened in funnel-like manner. The funnel-like widening or broadening 50 assists in the introduction of the second ferrule 40 into the sleeve 48 when the two coupling parts 14 and 16 are joined together. On account of the mounting of the holding element 46 with play, herein the ferrule 40 can automatically align itself in a manner aligned with the first ferrule 38 in the longitudinal direction of the sleeve 48 and herewith in the longitudinal direction of the rotation axis D. It is therefore ensured that on joining, the optical axes of the two ferrules 38 and 40 are aligned in the direction of the rotation axis D, so that the light entry and exit surfaces of the ferrules 38 and 40 lie opposite one another in an aligned manner. The light entry and exit surfaces here are designed as lenses, wherein as is indicated in FIGS. 1-4 they can be designed as one piece with the ferrules 38, 40 or however also be arranged as separate lenses 52 in front of the ferrules 38, 40, as is show in FIGS. 5 and 6. There, the lenses 52 are designed in a spherical manner. The movable mounting of the holding element 46 comprises a rotation lock as is represented in FIGS. 6 and 7. The rotation lock comprises a radially projecting projection 54 which engages into a correspondingly shaped recess 56 in the coupling part 16. The projection 54 also has play in the recess 56, so that a movement is possible transverse to the longitudinal axis D, but the rotation angle is limited.

The sleeve 48 can be removed from both ferules 38 and 40, but is held on the first ferrule 38 with a greater clamping force than on the second ferrule 40. By way of this, it is ensured that when the first coupling part 14 and the second coupling part 16 are pulled apart axially, the ferrule 40 always disengages from the sleeve 48, but the sleeve 48 remains on the first ferrule 38. The sleeve 48 can be withdrawn from this first ferrule 38, in order for example to be able to clean the lens 52 on the ferrule 38 or its axial light exit window. Moreover, the reduced pressing force on the outer circumference of the second ferrule 40 has the effect of the sleeve 48 being able to rotate or slide on the surface of this ferrule 40. A relative rotation of the ferrules 38 and 40 to one another about the rotation axis D is possible.

Apart from the optical coupling between the two optic fibers 26 and 28, as has been described above, the rotary coupling 12 also permits an electrical coupling between the electrical leads 29 and 30 on the one hand and the electrical leads 34 and 36 on the other hand. For this, a releasable electrical coupling is provided. In the shown example, this is formed by resilient contact pins 58 in the second coupling part 16 which come into electrically conductive contact at opposite counter-contact surfaces 60 in the first coupling part 14 when the two coupling parts 14 and 16 are connected to one another. As is to be recognized in FIGS. 5 and 7, the electrical coupling can comprise more than two contact pins 58 and corresponding counter-contact surfaces 60 which are circumferentially distributed about the rotation axis D. A slip ring coupling 62 which realizes the rotatability for the electrical coupling is arranged as an electric rotary coupling between the counter-contact surfaces 60 and the electrical leads 34 and 36. The slip ring coupling 62 is arranged concentrically to the rotation axis D and comprises a rotatable part which together with the holding element 44 is rotatably mounted in the roller bearings 42. A stationary part which is electrically connected to the counter-contact surfaces 60 via electrical leads 59 is arranged circumferentially.

With regard to the application of the rotary coupling according to the invention which is shown in FIG. 1, the inner part of the slip ring coupling 62 with the holding element 44 and the ferrule 38 which is arranged in this can be connected to the stationary part 10 of the reel 8 in a rotationally fixed manner, whereas the remainder of the rotary coupling together with the coupling parts 14 and 16 is rotatable with the reel 8. Hence the releasable part of the coupling lies in the rotating part. It is only with the optical coupling that the plug-in coupling and rotary coupling lie in one component, in which the ferrules 38, 40 can rotate to one another and can be pulled apart axially, in order to separate the optical connection. The mounting and guiding are herein ensured by the sleeve 48. Given the arrangement of a described rotary coupling 12 on the probe 2, for example the inner part of the slip ring coupling 62 with the connecting electrical leads 34 and 36 as well as with the holding element 44 and the ferrule 38 which is arranged in this can be connected to the cable 6, whereas the remainder of the rotary coupling 12 together with the coupling parts 14 and 16 is rotatable with the probe 2. However, in principle it would also be conceivable to connect the cable 6 and probe 2 or cable 6 and the stationary part 10 of the reel 8 to the rotary coupling 12 in a reverse configuration.

While specific embodiments of the invention have been shown and described in detail to illustrate the application of the principles of the invention, it will be understood that the invention may be embodied otherwise without departing from such principles.

### LIST OF REFERENCE NUMERALS

2 probe, camera probe
4 camera
6 cable
8 reel
10 stationary part
12 rotary coupling
14, 16 coupling parts
18 thread
20 union nut
22 pin
24 recess
26, 28 optic fiber
29, 30, 34, 36 electrical lead
38, 40 ferrules
42 roller bearing
44, 46 holding elements
48 sleeve
50 widening
52 lenses
54 projection
56 recess
58 contact pins
59 electrical leads
60 counter-contact surfaces
62 slip ring coupling
D rotation axis
X advance axis

What is claimed is:

1. A cavity inspection system and/or cavity machining system comprising:
at least one probe configured to be inserted into a cavity;
a cable connected to the probe, the cable comprising at least one optic fiber; and
a rotary coupling, wherein the rotary coupling comprises two coupling parts which are connected to one another or connectable to one another, so as to be rotationally fixed relative to each other; ferrules comprising a ferrule connected to an end of the optical fiber and a ferule connected to an end of another optic fiber, each of the ferrules being arranged in the two coupling parts, wherein at least one of the ferrules is rotatably mounted in the associated coupling part, a sleeve, wherein each of the ferrules is in engagement with the sleeve, such that the sleeve bears on an outer circumference of the respective ferrule such that the ferrules are aligned with one another by way of the surrounding sleeve and at least one of the ferrules is rotatable about a ferrule longitudinal axis in an inside of the sleeve.

2. A cavity inspection system and/or cavity machining system according to claim 1, wherein the ferrules have axial ends which face one another and comprise a light exit surface.

3. A cavity inspection system and/or cavity machining system according to claim 1, wherein the sleeve is configured to be resilient in a radial direction.

4. A cavity inspection system and/or cavity machining system according to claim 1, wherein in at least one of the two coupling parts the ferrule is arranged in a movable manner in at least one direction transverse to the ferrule longitudinal axis, wherein this ferrule is arranged in the associated coupling part rotationally fixed or rotationally limited.

5. A cavity inspection system and/or cavity machining system according to claim 1, wherein in at least one of the two coupling parts the ferrule is fixed in a holding element and the holding element is movably arranged in at least one direction transverse to the ferrule longitudinal axis, wherein this holding element is arranged in the associated coupling part rotationally fixed or rotationally limited.

6. A cavity inspection system and/or cavity machining system according to claim 1, wherein the rotary coupling is configured as a releasable coupling, wherein the two coupling parts can be joined together and are releasably connectable to one another, in an axial direction.

7. A cavity inspection system and/or cavity machining system according to claim 1, wherein the sleeve is configured to widen at an axial end.

8. A cavity inspection system and/or cavity machining system according to claim 1, wherein the sleeve is configured to be withdrawn from both ferrules in an axial direction.

9. A cavity inspection system and/or cavity machining system according to claim 1, wherein the ferrules and the sleeve are configured such that in an axial direction a holding force between the sleeve and a first of the ferrules is larger than a holding force between the sleeve and a second of the ferrules.

10. A cavity inspection system and/or cavity machining system according to claim 1, wherein the sleeve is configured with a widened axial end and the ferrule which engages into the widened axial end is arranged in the associated coupling part to be movable transversely to the ferrule longitudinal axis, wherein the ferrules and the sleeve are configured such that in an axial direction the holding force between the sleeve and the ferrule which engages into the widened axial end is smaller than the holding force between the sleeve and the other of the ferrules.

11. A cavity inspection system and/or cavity machining system according to claim 1, wherein the cable comprises at least one electrical lead and the rotary coupling comprises at least one electrical coupling.

12. A cavity inspection system and/or cavity machining system according to claim 11, wherein the electrical coupling comprises electrical contacts configured to be brought into engagement with one another and/or configured to be brought into bearing contact with one another.

13. A cavity inspection system and/or cavity machining system according to claim 11, wherein the electrical coupling is configured to be separable and rotationally fixed and wherein a non-separable electrical rotary feed-through is arranged in one of the two coupling parts.

14. A cavity inspection system and/or cavity machining system according to claim 11, wherein the at least one electrical coupling is arranged in a region of the coupling parts which circumferentially surrounds the ferrules.

15. A cavity inspection system and/or cavity machining system according to claim 1, wherein the rotary coupling connects an axial end of the cable to a reel, wherein one of the two coupling parts is connected to the axial end of the cable and the other of the two coupling parts is arranged on the reel.

16. A cavity inspection system and/or cavity machining system according to claim 1, wherein the rotary coupling connects an axial end of the cable to a camera or a camera probe, wherein one of the two coupling parts is connected to the axial end of the cable and the other of the two coupling parts is arranged on the camera or camera probe.

17. A cavity inspection system and/or cavity machining system according to claim 2, wherein the light exit surface comprises a lens.

18. A cavity inspection system and/or cavity machining system according to claim 3, wherein the sleeve has a slotted configuration.

19. A cavity inspection system and/or cavity machining system according to claim 11, wherein the at least one electrical coupling comprises a separable electrical coupling.

20. A rotary coupling for an optic fiber cable, for use in a cavity inspection system and/or cavity machining system, the rotary coupling comprising:
two coupling parts which are connected to one another or connectable to one another rotationally fixed;
ferrules comprising a ferrule which is connected to an end of an optic fiber and ferrule rotatably mounted in the associated coupling part, wherein each ferrule is arranged in the two coupling parts; and
a sleeve, wherein the ferrules are in engagement with the sleeve, such that the sleeve bears on an outer circumference of the respective ferrule such that the ferrules are aligned with one another by the surrounding sleeve and wherein at least one of the ferrules is rotatable in an inside of the sleeve about a ferrule longitudinal axis.
